(19) United States
(12) Patent Application Publication
(10) Pub. No.: US 2020/0071610 A1
(43) Pub. Date: Mar. 5, 2020

(54) LUMINESCENT PHOSPHOR SYSTEMS, METHODS OF PREPARING THE SAME, AND ARTICLES INCLUDING THE SAME

(71) Applicant: HONEYWELL INTERNATIONAL INC., Morris Plains, NJ (US)

(72) Inventors: Carsten Lau, Hannover (DE); Jan Schwedhelm, Springe (DE); Uwe Fischbeck, Sachsenhagen (DE)

(73) Assignee: HONEYWELL INTERNATIONAL INC., Morris Plains, NJ (US)

(21) Appl. No.: 16/541,566

(22) Filed: Aug. 15, 2019

Related U.S. Application Data
(60) Provisional application No. 62/723,683, filed on Aug. 28, 2018.

(51) Int. Cl. C09K 11/64; C09K 11/61; B42D 25/36

(52) U.S. Cl. CPC C09K 11/642; B42D 25/36; C09K 11/612

(57) ABSTRACT

Luminescent phosphor systems, methods of preparing luminescent phosphor systems, and articles that include the luminescent phosphor systems are provided herein. In an embodiment, a luminescent phosphor system includes a plurality of separate luminescent phosphor lots. The plurality of luminescent phosphor lots includes a first lot of a first luminescent phosphor compound and a second lot of a second luminescent phosphor compound. The first luminescent phosphor compound of the first lot includes zinc sulfide, copper ions, halogen ions and, optionally, at least one additional metal ion chosen from aluminum, manganese, and/or iron. The second luminescent phosphor compound of the second lot includes zinc sulfide, copper ions, halogen ions, and at least one additional metal ion chosen from aluminum and/or manganese. The first luminescent phosphor compound and the second luminescent phosphor compound have different decay time constants that are distinguishable by an authentication device.

### CROSS-REFERENCE TO RELATED APPLICATIONS

This application claims the benefit of U.S. Provisional Application No. 62/723,683, filed Aug. 28, 2018.

### TECHNICAL FIELD

The technical field generally relates to luminescent phosphor systems, methods of preparing the luminescent phosphor systems, and articles that include the luminescent phosphor systems. More particularly, the technical field relates to luminescent phosphor systems that include zinc sulfide-based luminescent phosphor compounds, and to methods of preparing the luminescent phosphor systems and articles that include the luminescent phosphor systems.

### BACKGROUND

A luminescent taggant or luminescent phosphor compound is a compound that is capable of emitting detectable quantities of radiation in the infrared, visible, and/or ultraviolet spectrums upon excitation of the compound by an external energy source. The chemistry of a luminescent phosphor compound may cause the compound to have particular emission properties and specific wavelengths for its excitation energy. Of course, it is to be appreciated that various factors beyond chemistry may also affect emission and/or excitation dynamics of the luminescent phosphor compounds.

For a specific luminescent phosphor compound that produces observable emissions, the spectral position(s) of a higher spectral energy content (or luminescent output) in its emissions (i.e., its “spectral signature”) may be used to uniquely identify the luminescent phosphor compound from other compounds. Temporal behavior of the emissions, such as decay times, may also be used to uniquely identify luminescent phosphor compounds from each other. Decay times for the luminescent phosphor compounds are based upon decay time constant (Tau) of the compounds. The Tau value is a function of intensity of emissions from the luminescent phosphor compounds over time, and multiple measurements of emission intensity over time can be taken to determine Tau by fitting a curve the measured emission intensity versus time measurements. For example, for a simple exponential decay in emission intensity, the decay time constant can be represented by the constant τ (Tau) in the equation:

I(t)=I₀e^{-t/τ}, (Equation 1)

where t denotes time, I denotes the emission intensity at time t, and Jo denotes the emission intensity at t=0 (e.g., t=0 may correspond to the instant when the provision of exciting radiation is discontinued). While Tau may be difficult to determine in some circumstances due to exponential nature of the decay, it is possible to approximate Tau values, or decay time, generally by comparing drop in emission intensity of different luminescent phosphor compounds at predetermined time intervals after discontinuation of excitation (e.g., after 0.5 ms, after 1 ms, after 1.5 ms, etc.).

The unique spectral and/or temporal properties of some luminescent phosphor compounds make them well suited for use in authenticating or identifying articles of particular value or importance (e.g., banknotes, passports, biological samples, and so on). Accordingly, luminescent phosphor compounds with known spectral signatures and/or temporal properties have been incorporated into various types of articles to enhance the ability to detect forgeries or counterfeit copies of such articles, or to identify and track the articles. For example, luminescent taggants have been incorporated into various types of articles in the form of additives, coatings, and printed or otherwise applied features that may be analyzed in the process of authenticating or tracking an article.

An article that includes a luminescent phosphor compound may be authenticated using specially designed authentication equipment. More particularly, a manufacturer may incorporate a known luminescent phosphor compound into its “authentic” articles. Authentication equipment configured to detect the authenticity of such articles would have knowledge (e.g., stored information and/or a variety of spectral filters) of the wavelengths of absorbable excitation energy and the spectral properties of emissions associated with the authenticating luminescent phosphor compound. When provided with a sample article for authentication, the authentication equipment exposes the article to excitation energy having wavelengths that correspond with the known wavelengths of absorption features of the luminescent phosphor compound that lead directly or indirectly to the desired emissions. The authentication equipment senses and characterizes the spectral parameters for any emissions that may be produced by the article. When the spectral signal of detected emissions is within the authenticating parameter range of the detection apparatus that corresponds with the authenticating luminescent phosphor compound (referred to as the “detection parameter space”), the article may be considered authentic. Conversely, when the authentication equipment fails to sense signals expected within the detection parameter space, the article may be considered unauthentic (e.g., a forged or counterfeited article).

The selection of the luminescent phosphor compounds for a particular application may be based upon excitation dynamics of the luminescent phosphor compounds. UV-excitable luminescent phosphor compounds are known and are commonly used in security documents or machine-readable documents. With improvements in light emitting diode (LED) technology, LEDs are now available that have sharp excitation profiles with a peak emission of about 365 nm, thus giving rise to a desire to provide luminescent phosphor compounds with improved excitation performance at 365 nm. Improved excitation manifests as brighter emission intensity of the luminescent phosphor compounds, which is desirable as a greater emission effect can be achieved with less of the luminescent phosphor compound.

The selection of the luminescent phosphor compounds may also be based on the desired emission color. One particular class of luminescent phosphor compounds that is capable of excitation in a band encompassing 365 nm, with green or blue emissions, is zinc sulfide-based luminescent phosphor compounds. The zinc sulfide-based luminescent phosphor compounds are activated with one or more metal ions, such as copper, aluminum, manganese, silver, gold, bismuth, gallium, indium, etc., as is known in the art. Efforts have been made to formulate zinc sulfide-based luminescent phosphor compounds to achieve emissions of a particular color, or to implement modifications to such luminescent phosphor compounds without extinguishing the emissions therefrom in the visible spectrum. However, compromise of emission intensity is often a consequence of modifying zinc sulfide-based luminescent phosphor compounds. Further, when formulating luminescent phosphor compounds for authentication applications, there is a general desire to provide a plurality of different luminescent phosphor compounds in a system to be used for distinguishing different types of similar articles, e.g., different denominations of currency. Differences between the luminescent phosphor compounds based only upon color are generally insufficient, and there is a general desire to provide luminescent phosphor compounds that further exhibit differences in temporal properties.

Accordingly, although a number of luminescent phosphor compounds have been developed to facilitate article authentication in the above-described manner, it is desirable to develop luminescent phosphor systems and methods of preparing luminescent phosphor systems that include luminescent phosphor compounds that are excitable at UV wavelengths, especially those that exhibit excellent excitation performance at 365 nm, and that are distinguishable on the basis of temporal properties. Furthermore, other desirable features and characteristics will become apparent from the subsequent detailed description and the appended claims, taken in conjunction with the accompanying drawings and this background.

### BRIEF SUMMARY

Luminescent phosphor systems, methods of preparing luminescent phosphor systems, and articles that include the luminescent phosphor systems are provided herein. In an embodiment, a luminescent phosphor system includes a plurality of separate luminescent phosphor lots. The plurality of luminescent phosphor lots includes a first lot of a first luminescent phosphor compound and a second lot of a second luminescent phosphor compound. The first luminescent phosphor compound of the first lot includes zinc sulfide, copper ions, halogen ions and, optionally, at least one additional metal ion chosen from aluminum, manganese, and/or iron. The second luminescent phosphor compound of the second lot includes zinc sulfide, copper ions, halogen ions, and at least one additional metal ion chosen from aluminum and/or manganese. The first luminescent phosphor compound and the second luminescent phosphor compound have different decay time constants that are distinguishable by an authentication device.

In another embodiment, a method of preparing a luminescent phosphor system that includes a plurality of luminescent phosphor lots is provided. In accordance with the method, a first lot of a first luminescent phosphor compound is provided. The first luminescent phosphor compound includes zinc sulfide, copper ions, halogen ions and, optionally, at least one additional metal ion chosen from aluminum, manganese, and/or iron. A second lot of a second luminescent phosphor compound is selected based upon the second luminescent phosphor compound having a different decay time constant than the first luminescent phosphor compound with the different decay time constants distinguishable by an authentication device. The second luminescent phosphor compound includes zinc sulfide, copper ions, halogen ions, and at least one additional metal ion chosen from aluminum and/or manganese.

In another embodiment, articles including a luminescent phosphor system are provided. The articles include a first article and a second article. The first article includes a substrate and a first authentication feature on a surface of the substrate or integrated within the substrate. The first authentication feature includes a first luminescent phosphor compound from a first lot. The first luminescent phosphor compound includes zinc sulfide, copper ions, halogen ions and, optionally, at least one additional metal ion chosen from aluminum, manganese, and/or iron. The second article includes a substrate and a second authentication feature on a surface of the substrate or integrated within the substrate. The second authentication feature is different from the first authentication feature and includes a second luminescent phosphor compound from a second lot. The second luminescent phosphor compound includes zinc sulfide, copper ions, halogen ions, and at least one additional metal ion chosen from aluminum and/or manganese.

### BRIEF DESCRIPTION OF THE DRAWINGS

The present disclosure will hereinafter be described in conjunction with the following drawing figures, wherein like numerals denote like elements, and wherein:

FIG. 1 is a contour diagram showing decay time constant for various luminescent phosphor compounds including zinc sulfide, aluminum ions, and copper ions based upon copper and aluminum content, in parts per million, calculated with MINITAB 17 statistical software package;

FIG. 2 is a graph illustrating relative emission intensity at 365 nm excitation for various luminescent phosphor compounds including zinc sulfide based on various combinations of copper and aluminum and/or manganese present in the luminescent phosphor compounds; and

FIG. 3 is a luminescent article that includes a luminescent phosphor system in accordance with an embodiment.

### DETAILED DESCRIPTION

The following detailed description is merely exemplary in nature and is not intended to limit the luminescent phosphor systems, methods of preparing the luminescent phosphor systems, or articles that include the luminescent phosphor systems. Furthermore, there is no intention to be bound by any theory presented in the preceding background or the following detailed description.

Luminescent phosphor systems, methods of preparing luminescent phosphor systems, and articles that include the luminescent phosphor systems are provided herein. The luminescent phosphor systems include a plurality of separate luminescent phosphor lots, where each separate lot includes a different type of luminescent phosphor compound that is based on zinc sulfide. The different types of luminescent phosphor compounds in the respective lots have different decay time constants that are distinguishable by an authentication device, and the separate luminescent phosphor lots can be distinguished from each other at least on the basis of differences in decay time constant. Notably, it was recognized that various combinations of metal ions in the luminescent phosphor compounds can be employed, in varying amounts, to effectuate changes to decay time constant of the luminescent phosphor compounds that include zinc sulfide. Even more, it was found that inclusion of certain metal ions, as a secondary ion in addition to copper, can effectuate a decrease in decay time constant while remaining neutral to or increasing emission intensity under excitation at 365 nm. For example, it was found that inclusion of aluminum ions decreases decay time constant while remaining neutral to or increasing emission intensity. Thus, luminescent phosphor systems are realized that include luminescent phosphor compounds that are excitable at UV wavelengths, owing to the luminescent phosphor compounds being based on zinc sulfide, that are distinguishable on the basis of temporal properties, and that may exhibit a unique combination of shortened decay time constant without a detrimental impact on emission intensity.

As alluded to above, the luminescent phosphor systems include a plurality of separate and different luminescent phosphor lots. More particularly, the separate luminescent phosphor lots have different luminescent phosphor compounds and exhibit different luminescent properties. In this regard, different lots of the luminescent phosphor system can be employed in different authentication features to enable distinction between the different authentication features, as described in further detail below. By providing the luminescent phosphor system including the separate and different luminescent phosphor lots, flexibility with providing distinct authentication features can be easily realized.

The plurality of separate luminescent phosphor lots includes a first lot of a first luminescent phosphor compound and a second lot of a second luminescent phosphor compound, although it is to be appreciated that numerous additional lots of additional, distinct luminescent phosphor compounds may also be provided. The first lot of the first luminescent phosphor compound principally includes the first luminescent phosphor compound, to the substantial exclusion of other luminescent phosphor compounds. For example, in embodiments, the first lot of the first luminescent compound includes at least 99 weight % of the first luminescent phosphor compound, based upon the total weight of all luminescent phosphor compounds present in the first luminescent phosphor lot. It is to be appreciated that other, non-luminescent phosphor components may optionally be present in the first luminescent phosphor lot.

The first luminescent phosphor compound includes zinc sulfide, copper ions, halogen ions and, optionally, at least one additional metal ion chosen from aluminum, manganese, and/or iron. The halogen ion is a residual ion present in the first luminescent phosphor compound as a consequence of fabrication of the first luminescent phosphor compound in which halogen-containing flux is employing, as described in further detail below. In embodiments, the first luminescent phosphor compound is free of the at least one additional metal ion, i.e., the first luminescent phosphor compound only includes copper ions and zinc ions. In this embodiment, the copper ions may be present up to amounts that would result in a visibly gray color of the first luminescent phosphor compound, e.g., up to about 2000 ppm. In other embodiments, the first luminescent phosphor compound includes the at least one additional metal ion, which has the effect of modifying decay time constant and emission intensity of the first luminescent phosphor compound. The concentrations of the ions are described herein in mass or weight ppm based upon the weight of the zinc sulfide in a raw material blend prior to synthesis of the first luminescent compound. More particularly, the weight of zinc sulfide included in the first luminescent phosphor is determined in the raw material blend, and the weight of the zinc sulfide may be considered very similar in the final first luminescent phosphor although deviations may occur as material may evaporate during synthesis of the first luminescent phosphor compound. In embodiments, the first luminescent phosphor compound includes copper, as added to the zinc sulfide during synthesis and expressed in weight ppm based on weight of the zinc sulfide, in an amount of from about 600 to about 2000 weight ppm (corresponding to a decimal value of about 0.0006 weight percent to about 0.002 weight percent based on the weight of the zinc sulfide). The first luminescent phosphor compound further includes the at least one additional metal ion chosen from aluminum, manganese, and/or ion, and also includes a halogen ion that remains present as a result of fabrication of the first luminescent phosphor compound. The amount of copper can alternatively be from about 600 ppm to about 1800 ppm, or from about 900 to about 1800 ppm, or from about 1200 to about 1800 ppm. It was found that higher amounts of copper correlate to higher emission intensity at 365 nm excitation and shorter decay time constant, although the amount of copper is limited at about 2000 ppm to avoid a visibly gray color of the first luminescent phosphor compound.

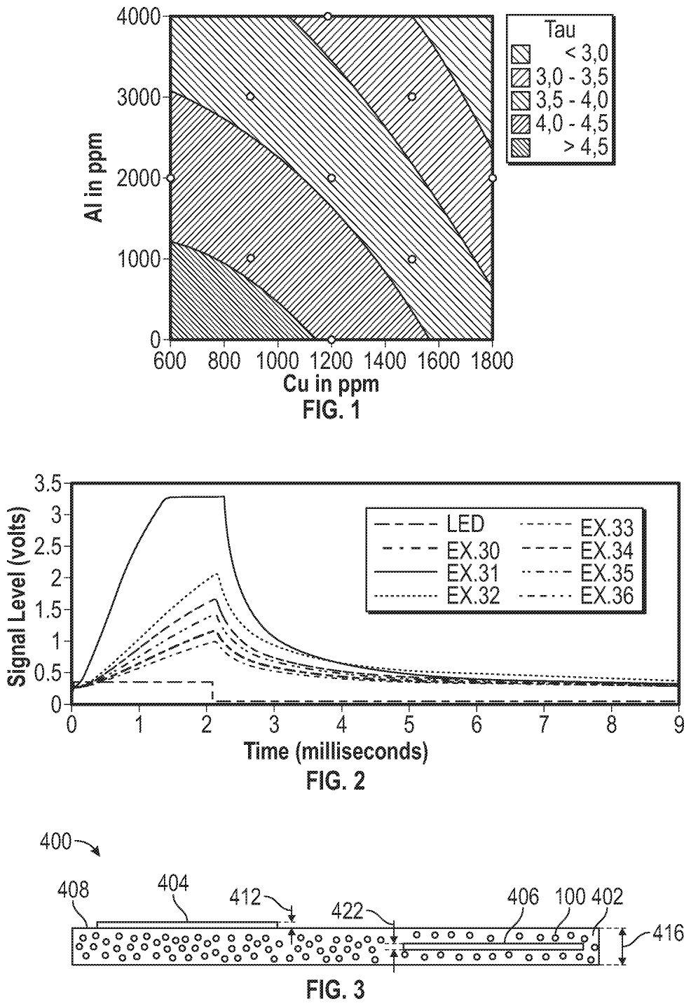

When present, the amount of the at least one additional metal ion may depend upon the type of the at least one additional metal ion. However, aluminum can contribute to an even shorter decay time constant than can be achieved with copper alone, and manganese and iron ions have a different effect on emission intensity at 365 nm excitation. In an embodiment, the at least one additional metal ion includes aluminum, which both shortens the decay time constant and increases emission intensity at 365 nm excitation as compared to comparable luminescent phosphor compounds that include copper alone at equal amounts of copper. FIG. 1 illustrates the effect on decay time constant based upon relative amounts of copper and aluminum present in the luminescent phosphor compound, and details regarding FIG. 1 are addressed in further detail below. In embodiments in which aluminum is present in the first luminescent phosphor compound, the aluminum may be present in an amount of from greater than 0 to about 4000 ppm, such as from about 1000 to about 4000 ppm, or such as from about 2000 to about 4000 ppm, with the amount of aluminum limited at about 4000 ppm to avoid handling difficulties for the first luminescent phosphor compound.

In another embodiment, the at least one additional metal ion includes manganese, either alone or in addition to aluminum. Manganese is either neutral to or decreases emission intensity of the luminescent phosphor compounds at 365 nm excitation with increasing amounts of manganese. FIG. 2 illustrates relative emission intensity at 365 nm excitation for various luminescent phosphor compounds based on various combinations of copper, aluminum, and/or manganese present in the luminescent phosphor compounds, and details regarding FIG. 2 are addressed in further detail below. In embodiments, the manganese is neutral to emission intensity at 365 nm excitation and is present in an amount of from greater than 0 to 500 ppm. In other embodiments, the manganese is present in higher amounts, such as from about 500 to about 1000 ppm, or such as from about 1000 to about 5000 ppm and decreases intensity of the first luminescent phosphor at 365 nm excitation. For example, at 5000 ppm manganese, a decrease in intensity of about 50% may be observed, which may be a desirable effect in some applications. In a further embodiment, the at least one additional metal ion includes iron, either alone or in addition to aluminum and/or manganese. A combination of any of the aforementioned additional metal ions contributes to decay time constant and emission intensity based upon the above-noted observations.

As alluded to above, the luminescent phosphor system further includes the second lot of the second luminescent phosphor compound. Like the first luminescent phosphor compound, the second luminescent phosphor compound includes zinc sulfide, copper ions, and halogen ions. Additionally, the second luminescent phosphor compound includes at least one additional metal ion chosen from aluminum and/or manganese. The first luminescent phosphor compound and the second luminescent phosphor compound within the luminescent phosphor system are distinguishable on the basis of the respective decay time constants of the respective first and second luminescent phosphor compounds in any given luminescent phosphor system. In this regard, the first and second luminescent phosphor compounds generally encompass overlapping genii, although the first luminescent phosphor compound is broader in that it additionally encompasses luminescent phosphor compounds that do not include the at least one additional metal ion. In embodiments, the second luminescent phosphor compound includes copper, as added to the zinc sulfide during synthesis and expressed in weight ppm based on weight of the zinc sulfide, in an amount of from about 600 to about 2000 weight ppm (corresponding to a decimal value of about 0.0006 weight percent to about 0.002 weight percent based on the weight of the zinc sulfide). The second luminescent phosphor compound further includes the at least one additional metal ion chosen from aluminum and/or manganese in an amount, as added to the zinc sulfide during synthesis and expressed in weight ppm based on weight of the zinc sulfide, of from greater than 0 to about 4000 ppm (corresponding to a decimal value of about 0.004 weight percent based on the weight of the zinc sulfide). The second luminescent phosphor compound further includes a halogen ion that remains present as a result of fabrication of the second luminescent phosphor compound. The amount of copper in the second luminescent phosphor compound can alternatively be from about 600 ppm to about 1800 ppm, or from about 900 to about 1800 ppm, or from about 1200 to about 1800 ppm. In an embodiment, the at least one additional metal ion includes aluminum, and the aluminum may be present in an amount of from greater than 0 to about 4000 ppm, such as from about 1000 to about 4000 ppm, or such as from about 2000 to about 4000 ppm. In another embodiment, the at least one additional metal ion includes manganese, either alone or in addition to aluminum. In embodiments, the manganese is neutral to emission intensity at 365 nm excitation and is present in an amount of from greater than 0 to 500 ppm. In other embodiments, the manganese is present in higher amounts, such as from about 1000 to about 5000 ppm, or such as from about 1000 to about 3000, and decreases intensity of the second luminescent phosphor at 365 nm excitation.

Various combinations of luminescent phosphor compounds may be provided in the first and second lots, provided that the respective luminescent phosphor compounds have different decay time constants that are distinguishable by an authentication device. By providing the first and second luminescent phosphor compounds in the respective lots that all include zinc sulfide and copper ions but that have different decay time constants, various combinations of luminescent phosphor compounds are possible that include similar chemistry and that provide a similar visible emission (such as emissions in visible green or blue bands), but with distinguishable temporal properties that enable differentiation and a variety of solutions within the field of authentication.

Differences between the decay time constants of the first luminescent phosphor compound and the second luminescent phosphor compound are not limited provided that the difference between decay time constants can be determined using conventional authentication devices. Decay time constant, or Tau, can be measured by exciting the luminescent phosphor compounds with a light source that provides electromagnetic radiation centered at 365 nm, switching off the exciting light source, and measuring intensity of emissions from the luminescent phosphor compounds over time. For example, in an embodiment, a silicon based detector device and an oscilloscope may be employed to determine intensities at time intervals on the millisecond scale, such as every 0.5 ms after switching off the exciting light source. Multiple data points may be taken over time and plotted on a voltage versus time graph. A curve may be fit on the voltage versus time graph for the data points to determine the rate of decay for the luminescent phosphor compounds. For example, for a simple exponential decay in emission intensity, the decay time constant can be represented by the constant ti (Tau) in the equation:

I(t)=I₀e^{t/τ}, (Equation 1)

where t denotes time, I denotes the emission intensity at time t, and Jo denotes the emission intensity at t=0 (e.g., t=0 may correspond to the instant when the provision of exciting radiation is discontinued). In an embodiment used to calculate Tau values as provided in the Examples, Tau is calculated based on the baseline-corrected intensities that were measured 3 ms and 8 ms after the excitation was discontinued (baseline correction was applied for each graph.) While Tau may be difficult to determine in some circumstances due to multi-exponential nature of the decay, it is possible to approximate Tau values, or decay time, generally by comparing drop in emission intensity of different luminescent phosphor compounds at predetermined time intervals after discontinuation of excitation (e.g., after 0.5 ms, after 1 ms, after 1.5 ms, etc.). In embodiments, the first luminescent phosphor compound and the second luminescent phosphor compound have decay time constants that are different by at least 0.1 ms, alternatively different by at least 0.5 ms, or alternatively different by at least 1.0 ms.

By providing the first and second luminescent phosphor compounds in the respective lots that all include zinc sulfide and copper ions but that have different decay time constants, various combinations of luminescent phosphor compounds are possible that have similar chemistry and that provide a similar visible emission (such as emissions in visible green, orange, or blue bands), but with distinguishable temporal properties that enable differentiation and a variety of solutions within the field of authentication. In embodiments, the first luminescent phosphor compound and the second luminescent phosphor compound have substantially the same amount of aluminum and different amounts of copper. In other embodiments, the first luminescent phosphor compound and the second luminescent phosphor compound have substantially the same amount of copper and different amounts of aluminum. In additional examples, the first luminescent phosphor compound and the second luminescent phosphor compound have a different amount of aluminum and a different amount of copper. Similar combinations also apply for respective amounts of manganese between the first and second luminescent phosphor compounds, with or without aluminum present.

Although not intended to be limiting, examples of luminescent phosphor systems including the plurality of separate luminescent phosphor lots include the following combinations:
a first lot of a first luminescent phosphor compound, wherein the first luminescent phosphor compound includes zinc sulfide, copper ions in an amount of from about 600 to about 900 ppm, and aluminum ions in an amount of from 0 to less than about 2000 ppm; and a second lot of a second luminescent phosphor compound, wherein the second luminescent phosphor compound includes zinc sulfide, copper ions in an amount of from about 900 to about 1800 ppm, and aluminum ions in an amount of from 2000 to about 4000 ppm, provided that the second lot of the second luminescent phosphor compound has a decay time constant of less than 4.0 ms;
first lot of a first luminescent phosphor compound, wherein the first luminescent phosphor compound includes zinc sulfide, copper ions in an amount of from about 600 to about 900 ppm, and aluminum ions in an amount of from 0 to about 2000 ppm; and a second lot of a second luminescent phosphor compound, wherein the second luminescent phosphor compound includes zinc sulfide, copper ions in an amount of from about 1200 to about 1800 ppm, and aluminum ions in an amount of from 2000 to about 4000 ppm, provided that the first lot of the first luminescent phosphor compound has a decay time constant of greater than 4.0 ms and/or the second lot of the second luminescent phosphor compound has a decay time constant of less than 3.5 ms;
first lot of a first luminescent phosphor compound, wherein the first luminescent phosphor compound includes zinc sulfide, copper ions in an amount of from about 600 to about 900 ppm, and aluminum ions in an amount of from 0 to about 4000 ppm; and a second lot of a second luminescent phosphor compound, wherein the second luminescent phosphor compound includes zinc sulfide, copper ions in an amount of from about 1500 to about 1800 ppm, and aluminum ions in an amount of from 2000 to about 4000 ppm, provided that the second lot of the second luminescent phosphor compound has a decay time constant of less than 3.5 ms;
first lot of a first luminescent phosphor compound, wherein the first luminescent phosphor compound includes zinc sulfide, copper ions in an amount of from about 600 to about 1200 ppm, and aluminum ions in an amount of from 0 to about 4000 ppm; and a second lot of a second luminescent phosphor compound, wherein the second luminescent phosphor compound includes zinc sulfide, copper ions in an amount of from about 1500 to about 1800 ppm, and aluminum ions in an amount of from 2000 to about 4000 ppm, provided that the first lot of the first luminescent phosphor compound has a decay time constant of greater than 3.5 ms and the second lot of the second luminescent phosphor compound has a decay time constant of less than 3.5 ms;
first lot of a first luminescent phosphor compound, wherein the first luminescent phosphor compound includes zinc sulfide, copper ions in an amount of from about 600 to about 900 ppm, and aluminum ions in an amount of from 0 to about 1000 ppm; and a second lot of a second luminescent phosphor compound, wherein the second luminescent phosphor compound includes zinc sulfide, copper ions in an amount of from about 900 to about 1800 ppm, and aluminum ions in an amount of from 1000 to about 4000 ppm, provided that the second lot of the second luminescent phosphor compound has a decay time constant of less than 4.0 ms;
first lot of a first luminescent phosphor compound, wherein the first luminescent phosphor compound includes zinc sulfide, copper ions in an amount of from about 600 to about 1200 ppm, and has about 0 aluminum ions; and a second lot of a second luminescent phosphor compound, wherein the second luminescent phosphor compound includes zinc sulfide, copper ions in an amount of from about 600 to about 1800 ppm, and aluminum ions in an amount of from about 1000 to about 4000 ppm, provided that the first lot of the first luminescent phosphor compound has a decay time constant of greater than 4.5 ms;
first lot of a first luminescent phosphor compound, wherein the first luminescent phosphor compound includes zinc sulfide, copper ions in an amount of from about 600 to about 1400 ppm; and a second lot of a second luminescent phosphor compound, wherein the second luminescent phosphor compound includes zinc sulfide, copper ions in an amount of from about 900 to about 1800 ppm, and aluminum ions in an amount of from 1500 to about 4000 ppm, provided that the second luminescent phosphor compound has a decay time constant of less than 4.0 ms;
first lot of a first luminescent phosphor compound, wherein the first luminescent phosphor compound includes zinc sulfide, copper ions in an amount of from about 600 to about 1200 ppm, and aluminum ions in an amount of from 0 to about 2000 ppm; and a second lot of a second luminescent phosphor compound, wherein the second luminescent phosphor compound includes zinc sulfide, copper ions in an amount of from about 900 to about 1800 ppm, and aluminum ions in an amount of from 1000 to about 4000 ppm, provided the first and second luminescent phosphor compounds have a difference in decay time constant of at least 0.1 under excitation at 365 nm;
first lot of a first luminescent phosphor compound, wherein the first luminescent phosphor compound includes zinc sulfide, copper ions in an amount of from about 600 to about 900 ppm, and aluminum ions in an amount of from 0 to about 3000 ppm; and a second lot of a second luminescent phosphor compound, wherein the second luminescent phosphor compound includes zinc sulfide, copper ions in an amount of from about 1200 to about 1800 ppm, and aluminum ions in an amount of from 1000 to about 4000 ppm; provided the first and second luminescent phosphor compounds have a difference in decay time constant of at least 0.1 under excitation at 365 nm;
first lot of a first luminescent phosphor compound, wherein the first luminescent phosphor compound includes zinc sulfide, copper ions in an amount of from about 600 to about 1500 ppm, and aluminum ions in an amount of from 0 to about 4000 ppm; and a second lot of a second luminescent phosphor compound, wherein the second luminescent phosphor compound includes zinc sulfide, copper ions in an amount of from about 1500 to about 1800 ppm, and aluminum ions in an amount of from 1000 to about 4000 ppm; provided the first and second luminescent phosphor compounds have a difference in decay time constant of at least 0.1 under excitation at 365 nm.

A method of preparing the luminescent phosphor system that includes the plurality of luminescent phosphor lots will now be described. To prepare the luminescent phosphor system, a first lot of the first luminescent phosphor compound is provided, where the first luminescent phosphor compound is as described above. The first luminescent phosphor compound can effectively be any zinc sulfide-based luminescent phosphor that includes copper, and the first luminescent phosphor compound represents a baseline material that is a starting point for purposes of establishing properties of a second luminescent phosphor compound that has a distinguishable decay time constant. As such, the method further includes selecting a second lot of a second luminescent phosphor compound based upon the second luminescent phosphor compound having a different decay time constant than the first luminescent phosphor compound distinguishable by an authentication device. The first and second luminescent phosphor compounds may be synthesized through conventional techniques whereby zinc sulfide, a metal ion source, and halogen flux material is blended to form a precursor blend, followed by firing the precursor blend to form the luminescent phosphor compounds. Conventional blending and firing conditions may be employed to yield the luminescent phosphor compounds.

The luminescent phosphor compounds as described herein may be employed in a luminescent material that includes, in addition to the luminescent phosphor compound 100, a medium. The medium may be chosen from the group of an ink, an ink additive, a glue, a liquid, a gel, a polymer, a slurry, a plastic, plastic base resin, a glass, a ceramic, a metal, a textile, wood, fiber, paper pulp, and paper. For example, but not by way of limitation, the medium may correspond to material employed to form a substrate of an article, or the medium may correspond to a material that may be applied to (e.g., printed on, coated on, sprayed on, or otherwise adhered to or bonded to) the surface of an article substrate, or the medium may correspond to material employed to form a feature that is embedded within a substrate (e.g., an embedded feature, a security thread, and so on). In the former case, the luminescent phosphor compounds may be incorporated into a substrate material, for example, by combining the luminescent phosphor compound with the medium and then forming the substrate with the medium, and/or by impregnating the medium with a colloidal dispersion of particles of the luminescent phosphor compound. Impregnation may be performed, for example, by a printing, dripping, coating or spraying process.

An embodiment of luminescent articles that include the luminescent phosphor system will now be described with reference to FIG. 3. FIG. 3 depicts a cross-sectional view of an article 400 that includes one type of luminescent phosphor compound 100, according to an example embodiment. The luminescent phosphor compound 100 can be either the first luminescent phosphor compound from the first lot, or can be the second luminescent phosphor compound from the second lot depending upon the particular article, with different articles including the respective first luminescent phosphor compound or the second luminescent phosphor compound. It is to be appreciated that, in accordance with the embodiments described herein, at least a first article and a second article are provided that separately include the first luminescent phosphor compound or the second luminescent phosphor compound, and the article 400 shown in FIG. 3 is representative of various embodiments of the first and second articles.

The article 400 includes a substrate 402 and an authentication feature 404, 406 on a surface 408 of the substrate 402 or integrated within the substrate 402, with the authentication feature 404, 406 including the luminescent phosphor compound 100. For example, this may be accomplished by incorporating the luminescent material, which includes the medium and luminescent phosphor compound 100, in or on the article 400. Alternatively, the luminescent material may actually be employed as the base material for the substrate 402. Conversely, in embodiments in which the luminescent material is applicable to the surface 408 of the substrate 402, the luminescent material may be printed onto one or more surfaces 408 of the substrate 402 in pre-determined locations. Conversely, when the luminescent material corresponds to an embedded authentication feature 406, the embedded authentication feature 406 is integrated with the substrate material when the substrate material is in a malleable form (e.g., when the material is a slurry, molten, or non-cured form). In any one of the above-described manners, the luminescent material or luminescent phosphor compound described herein may be incorporated into an article 400.

As alluded to above, the luminescent material may be incorporated in or on the article 400. In particular, in this embodiment, the article 400 may include surface-applied and/or embedded authentication features 404, 406 that include the luminescent phosphor compound 100, and/or the article 400 may include particles of the luminescent phosphor compound 100 that are evenly or unevenly dispersed within one or more components of the article 400 (e.g., within substrate 402 and/or one or more layers or other components of the article 400). The various relative dimensions of the authentication features 404, 406 and particles of the luminescent phosphor compound 100 may not be to scale in FIG. 3. Although article 400 is illustrated to include both surface-applied and/or embedded authentication features 404, 406 and particles of the luminescent phosphor compound 100, another article may include one or a combination of embedded authentication features 406, surface-applied authentication features 404, and dispersed particles of the luminescent phosphor compound 100. Finally, although only one surface-applied authentication feature 404 and one embedded authentication feature 406 are shown in FIG. 3, an article may include more than one of either type of authentication feature 404, 406.

In various embodiments, article 400 may be any type of article selected from a group that includes, but is not limited to, identification card, a driver's license, a passport, identity papers, a banknote, a check, a document, a paper, a stock certificate, a packaging component, a credit card, a bank card, a label, a seal, a token, a casino chip, a postage stamp, an animal, and a biological sample.

Substrate 402, which may be rigid or flexible, may be formed from one or more layers or components, in various embodiments. The variety of configurations of substrate 402 are too numerous to mention, as the luminescent phosphor compound 100 of the various embodiments may be used in conjunction with a vast array of different types of articles. Therefore, although a simple, unitary substrate 402 is illustrated in FIG. 3, it is to be understood that substrate 402 may have any of a variety of different configurations. For example, a substrate 402 may be a “composite” substrate that includes a plurality of layers or sections of the same or different materials. For example, but not by way of limitation, a substrate 402 may include one or more paper layers or sections and one or more plastic layers or sections that are laminated or otherwise coupled together to form the composite substrate (e.g., a paper layer/plastic layer/paper layer or plastic layer/paper layer/plastic layer composite substrate). In addition, although inanimate, solid articles are discussed herein, it is to be understood that an “article” also may include a human, an animal, a biological specimen, a liquid sample, and virtually any other object or material into or onto which a luminescent material of an embodiment may be included.

Surface-applied authentication feature 404 may be, for example but not by way of limitation, a printed authentication feature or an authentication feature that includes one or more rigid or flexible materials into which or onto which luminescent phosphor compound 100 as described herein are included. For example, but not by way of limitation, the surface-applied authentication feature 404 may include an ink, pigment, coating, or paint that includes particles of a luminescent phosphor compound 100. Alternatively, the surface-applied authentication feature 404 may include one or more rigid or flexible materials into which or onto which particles of a luminescent phosphor compound 100 are included, where the surface-applied authentication feature 404 is then adhered or otherwise attached to the surface 408 of the substrate 402. According to various embodiments, surface-applied authentication feature 404 may have a thickness 412 of about one micron or more, and surface-applied authentication feature 404 may have a width and length that is less than or equal to the width and length of the substrate 402.

Embedded authentication feature 406 may include one or more rigid or flexible materials in which or onto which a luminescent phosphor compound 100 as described herein is included. For example, but not by way of limitation, embedded authentication feature 406 may be configured in the form of a discrete, rigid or flexible substrate, a security thread, or another type of structure. According to various embodiments, embedded authentication feature 406 may have a thickness 422 in a range of about one micron up to the thickness 416 of the substrate 402, and embedded authentication feature 406 may have a width and length that is less than or equal to the width and length of the substrate 402.

As mentioned above, particles of the luminescent phosphor compound 100 may be evenly or unevenly dispersed within substrate 402, as shown in FIG. 3, or within one or more other components of the article 400 (e.g., within one or more layers or other components of the article 400), in other embodiments. The particles of the luminescent phosphor compound 100 may be dispersed within substrate 402 or another component, for example but not by way of limitation, by mixing particles of the luminescent phosphor compound 100 into the medium that is employed to form the substrate 402 or other component, and/or by impregnating the substrate 402 or other component with a colloidal dispersion of the particles of the luminescent phosphor compound 100, as discussed previously.

The absorption and emission properties of embodiments of luminescent phosphor compounds discussed herein (e.g., luminescent phosphor compound 100 of FIG. 3) are consistent with their use in conjunction with security and authentication features. For example, using relatively conventional authentication equipment, embodiments of luminescent taggants 100, 200, 300 may be readily excited and the emissions detected through conventional techniques.

The following Examples are intended to supplement, and not to limit, the description of the luminescent phosphor systems and methods of producing the same as described above.

### Examples

Different lots of luminescent phosphor compounds are prepared that include zinc sulfide and various metal ions at different loadings within the luminescent phosphor compounds, and with residual halogen ions present as a result of preparation of the luminescent phosphor compounds. The luminescent phosphor compounds are prepared by blending zinc sulfide, copper chloride or copper sulfate, at least one metal ion source such as aluminum nitrate, aluminum chloride, aluminum sulfate, or manganese sulfate, and chloride flux material such as sodium chloride to form a precursor blend, followed by firing the precursor blend at temperatures from about 600 to below 1000° C. to form the luminescent phosphor compounds shown in TABLE I. Conventional blending and firing techniques may be employed to yield the luminescent phosphor compounds.

Examples of various combinations of first and second luminescent phosphor compounds are provided in TABLE I below, along with approximated differences in decay time constant (delta Tau) with all amounts in parts per million (ppm):

TABLE I

| | First Luminescent | | | | | Second Luminescent | | | | | |
|---|---|---|---|---|---|---|---|---|---|---|---|
| | Phosphor Compound | | | | | Phosphor Compound | | | | | |
| | | | | | Tau, | | | | | Tau, | Delta |
| Ex. | Cu | Al | Mn | Cl | ms | Cu | Al | Mn | Cl | ms | Tau, ms |
| 1 | 600 | 2000 | 0 | Resid | 4.26 | 900 | 3000 | 0 | Resid | 3.95 | 0.31 |
| 2 | 600 | 2000 | 0 | Resid | 4.26 | 1200 | 2000 | 0 | Resid | 3.84 | 0.42 |
| 3 | 600 | 2000 | 0 | Resid | 4.26 | 1200 | 4000 | 0 | Resid | 3.4 | 0.86 |
| 4 | 600 | 2000 | 0 | Resid | 4.26 | 1500 | 1000 | 0 | Resid | 3.94 | 0.32 |
| 5 | 600 | 2000 | 0 | Resid | 4.26 | 1500 | 3000 | 0 | Resid | 3.3 | 0.96 |
| 6 | 600 | 2000 | 0 | Resid | 4.26 | 1800 | 2000 | 0 | Resid | 3.06 | 1.20 |
| 7 | 900 | 1000 | 0 | Resid | 4.49 | 900 | 3000 | 0 | Resid | 3.95 | 0.54 |
| 8 | 900 | 1000 | 0 | Resid | 4.49 | 1200 | 2000 | 0 | Resid | 3.84 | 0.65 |
| 9 | 900 | 1000 | 0 | Resid | 4.49 | 1200 | 4000 | 0 | Resid | 3.40 | 1.09 |
| 10 | 900 | 1000 | 0 | Resid | 4.49 | 1500 | 1000 | 0 | Resid | 3.94 | 0.55 |
| 11 | 900 | 1000 | 0 | Resid | 4.49 | 1500 | 3000 | 0 | Resid | 3.30 | 1.19 |
| 12 | 900 | 1000 | 0 | Resid | 4.49 | 1800 | 2000 | 0 | Resid | 3.06 | 1.43 |
| 13 | 900 | 3000 | 0 | Resid | 3.95 | 1200 | 2000 | 0 | Resid | 3.84 | 0.11 |
| 14 | 900 | 3000 | 0 | Resid | 3.95 | 1200 | 4000 | 0 | Resid | 3.40 | 0.55 |
| 15 | 900 | 3000 | 0 | Resid | 3.95 | 1500 | 3000 | 0 | Resid | 3.30 | 0.65 |
| 16 | 900 | 3000 | 0 | Resid | 3.95 | 1800 | 2000 | 0 | Resid | 3.06 | 0.89 |
| 17 | 1200 | 0 | 0 | Resid | 4.46 | 900 | 3000 | 0 | Resid | 3.95 | 0.51 |
| 18 | 1200 | 0 | 0 | Resid | 4.46 | 1200 | 2000 | 0 | Resid | 3.84 | 0.62 |
| 19 | 1200 | 0 | 0 | Resid | 4.46 | 1200 | 4000 | 0 | Resid | 3.40 | 1.06 |
| 20 | 1200 | 0 | 0 | Resid | 4.46 | 1500 | 1000 | 0 | Resid | 3.94 | 0.52 |
| 21 | 1200 | 0 | 0 | Resid | 4.46 | 1500 | 3000 | 0 | Resid | 3.30 | 1.16 |
| 22 | 1200 | 0 | 0 | Resid | 4.46 | 1800 | 2000 | 0 | Resid | 3.06 | 1.40 |
| 23 | 1200 | 2000 | 0 | Resid | 3.84 | 1500 | 3000 | 0 | Resid | 3.30 | 0.54 |
| 24 | 1200 | 2000 | 0 | Resid | 3.84 | 1800 | 2000 | 0 | Resid | 3.06 | 0.78 |
| 25 | 1200 | 4000 | 0 | Resid | 3.40 | 1500 | 3000 | 0 | Resid | 3.30 | 0.10 |
| 26 | 1200 | 4000 | 0 | Resid | 3.40 | 1800 | 2000 | 0 | Resid | 3.06 | 0.34 |
| 27 | 1500 | 1000 | 0 | Resid | 3.94 | 1500 | 3000 | 0 | Resid | 3.30 | 0.64 |
| 28 | 1500 | 1000 | 0 | Resid | 3.94 | 1800 | 2000 | 0 | Resid | 3.06 | 0.88 |

It is to be appreciated that, within TABLE I above, designations of the “first luminescent phosphor compound” and the “second luminescent phosphor compound” can be interchangeable, except for circumstances in which the first luminescent phosphor compound includes only copper and zinc ions (i.e., in the embodiments in which no aluminum or manganese ions are present). Each of the above Examples are plotted in the contour diagram of FIG. 1 with distinctions between decay time constant illustrated. The plots in the contour diagram of FIG. 1 were calculated with MINITAB 17 statistical software package. A bifactorial DOE was set up with copper ion content and aluminum ion content as factors, and experimental data points were obtained at the center points (three replicates) as well as at the edge and star points of the full factorial design. The response surface or contour diagrams were then calculated by the software. The R square for this model is 96%, the R square adjusted is 95%, which indicates that the quality of the data is high.

Referring to FIG. 2, additional examples of various combinations of first and second luminescent phosphor compounds are provided, with differences in relative intensity between the first and second luminescent phosphors shown over time after excitation with an LED that produces electromagnetic radiation centered at 365 nm. Differences in decay time constant can also be derived from the changes in intensity over time for the various luminescent phosphor compounds. Chemistry for each of the Examples is provided in TABLE II below, with all amounts in parts per million (ppm):

TABLE II

| Ex. | Cu | Al | Mn | Cl |
|---|---|---|---|---|
| 30 | 800 | 0 | 4000 | Resid. |
| 31 | 1200 | 4000 | 0 | Resid. |
| 32 | 1000 | 0 | 1000 | Resid. |
| 33 | 600 | 0 | 3000 | Resid. |
| 34 | 1000 | 0 | 3000 | Resid. |
| 35 | 800 | 0 | 2000 | Resid. |
| 36 | 1000 | 0 | 3000 | Resid. |

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A luminescent phosphor system comprising:
a plurality of separate luminescent phosphor lots, wherein the plurality of luminescent phosphor lots comprises:
a first lot of a first luminescent phosphor compound, wherein the first luminescent phosphor compound comprises zinc sulfide, copper ions, halogen ions and, optionally, at least one additional metal ion chosen from aluminum, manganese, and/or iron; and
a second lot of a second luminescent phosphor compound, wherein the second luminescent phosphor compound comprises zinc sulfide, copper ions, halogen ions, and at least one additional metal ion chosen from aluminum or manganese;
wherein the first luminescent phosphor compound and the second luminescent phosphor compound have different decay time constants that are distinguishable by an authentication device.

2. The luminescent phosphor system of claim 1, wherein the first luminescent phosphor compound and the second luminescent phosphor compound have decay time constants that are different by at least 0.1.

3. The luminescent phosphor system of claim 2, wherein the first luminescent phosphor compound and the second luminescent phosphor compound have decay time constants that are different by at least 0.5.

4. The luminescent phosphor system of claim 3, wherein the first luminescent phosphor compound and the second luminescent phosphor compound have decay time constants that are different by at least 1.0.

5. The luminescent phosphor system of claim 1, wherein the aluminum ion is present as the least one additional metal ion in the second luminescent phosphor compound.

6. The luminescent phosphor system of claim 5, wherein aluminum ions are present in the second luminescent phosphor compound in an amount of from about 1000 to about 4000 ppm, expressed in weight ppm based on weight of the zinc sulfide.

7. The luminescent phosphor system of claim 6, wherein the second luminescent phosphor compound includes copper ions in an amount of from about 600 to about 2000 ppm, expressed in weight ppm based on weight of the zinc sulfide.

8. The luminescent phosphor system of claim 1, wherein the first luminescent phosphor compound comprises the at least one additional metal ion.

9. The luminescent phosphor system of claim 8, wherein the first luminescent phosphor compound comprises aluminum as the least one additional metal ion.

10. The luminescent phosphor system of claim 9, wherein the first luminescent phosphor compound and the second luminescent phosphor compound have substantially the same amount of aluminum and different amounts of copper.

11. The luminescent phosphor system of claim 9, wherein the first luminescent phosphor compound and the second luminescent phosphor compound have substantially the same amount of copper and different amounts of aluminum.

12. The luminescent phosphor system of claim 9, wherein the first luminescent phosphor compound further comprises manganese as the at least one additional metal ion.

13. The luminescent phosphor system of claim 1, wherein the second luminescent phosphor compound comprises manganese as the at least one additional metal ion.

14. The luminescent phosphor system of claim 1, wherein the first luminescent phosphor compound comprises:
copper in an amount of from about 600 ppm to about 2000 ppm;
at least one additional metal ion chosen from aluminum, manganese, and/or iron in an amount of from 0 to about 4000 ppm; and
a halogen ion that remains from fabrication of the first luminescent phosphor compound;
wherein all amounts are expressed in weight ppm based on weight of the zinc sulfide.

15. The luminescent phosphor system of claim 1, wherein the second luminescent phosphor compound comprises:
copper in an amount of from about 600 ppm to about 2000 ppm;
at least one additional metal ion chosen from aluminum and/or manganese in amount of from greater than 0 to about 4000 ppm; and
a halogen ion that remains from fabrication of the second luminescent phosphor compound;
wherein all amounts are expressed in weight ppm based on weight of the zinc sulfide.

16. A method of preparing a luminescent phosphor system comprising a plurality of luminescent phosphor lots, wherein the method comprises:
providing a first lot of a first luminescent phosphor compound, wherein the first luminescent phosphor compound comprises zinc sulfide, copper ions, halogen ions and, optionally, at least one additional metal ion chosen from aluminum, manganese, and/or iron; and
selecting a second lot of a second luminescent phosphor compound based upon the second luminescent phosphor compound having a different decay time constant than the first luminescent phosphor compound distinguishable by an authentication device, wherein the second luminescent phosphor compound comprises zinc sulfide, copper ions, halogen ions, and at least one additional metal ion chosen from aluminum and/or manganese.

17. Articles including a luminescent phosphor system, wherein the articles comprise:
a first article comprising a substrate and a first authentication feature on a surface of the substrate or integrated within the substrate, wherein the first authentication feature comprises a first luminescent phosphor compound from a first lot, wherein the first luminescent phosphor compound comprises zinc sulfide, copper ions, halogen ions and, optionally, at least one additional metal ion chosen from aluminum, manganese, and/or iron; and
a second article comprising a substrate and a second authentication feature on a surface of the substrate or integrated within the substrate, wherein the second authentication feature is different from the first authentication feature and comprises a second luminescent phosphor compound from a second lot, wherein the second luminescent phosphor compound comprises zinc sulfide, copper ions, halogen ions, and at least one additional metal ion chosen from aluminum and/or manganese.

18. Articles as set forth in claim 17, wherein the first authentication feature and the second authentication feature include the respective first luminescent phosphor compound and the second luminescent phosphor compound disposed in a luminescent material that includes a medium and the respective first luminescent phosphor compound or the second luminescent phosphor compound separate from the substrate.

19. Articles as set forth in claim 18, wherein the medium is chosen from the group of an ink, an ink additive, a glue, a liquid, a gel, a polymer, a slurry, a plastic, plastic base resin, a glass, a ceramic, a metal, a textile, wood, fiber, paper pulp, and paper.

20. Articles of claim 17, wherein the articles are selected from a group consisting of an identification card, a driver's license, a passport, identity papers, a banknote, a check, a document, a paper, a stock certificate, a packaging component, a credit card, a bank card, a label, a seal, a token, a casino chip, a postage stamp, an animal, and a biological sample.
